(19) United States
(12) Patent Application Publication
(10) Pub. No.: US 2026/0147943 A1
(43) Pub. Date: May 28, 2026

(54) STORAGE CONTROLLER ALLOCATING LOCKING DOMAIN, STORAGE DEVICE INCLUDING THE SAME, AND METHOD OF OPERATING THE SAME

(71) Applicant: Samsung Electronics Co., Ltd., Suwon-si (KR)

(72) Inventors: Junyoung PARK, Suwon-si (KR); Wonje HEO, Suwon-si (KR); Jisoo KIM, Suwon-si (KR); Younsung CHU, Suwon-si (KR)

(73) Assignee: Samsung Electronics Co., Ltd., Suwon-si (KR)

(21) Appl. No.: 19/298,966

(22) Filed: Aug. 13, 2025

(30) Foreign Application Priority Data
Nov. 22, 2024 (KR) 10-2024-0168711

(51) Int. Cl. G06F 21/79; G06F 12/14; G06F 21/60

(52) U.S. Cl. CPC G06F 21/79; G06F 12/145; G06F 21/602

(57) ABSTRACT

A storage device may include a storage controller and a non-volatile memory device. The storage controller may assign a first locking domain for first user data of a first namespace and second user data of a second namespace based on a first assignment request of a host device, generate a first KEK dedicated to the first locking domain, store first encrypted user data, the first encrypted user data generated by encrypting the first user data using a first media encryption key (MEK), store second encrypted user data, the second encrypted user data generated by encrypting the second user data using a second MEK, store a first encrypted MEK generated by encrypting the first MEK using the first KEK, and store a second encrypted MEK generated by encrypting the second MEK using the first KEK.

### CROSS-REFERENCE TO RELATED APPLICATIONS

This U.S. non-provisional application claims the benefit of priority under 35 U.S.C. § 119 to Korean Patent Application No. 10-2024-0168711 filed on Nov. 22, 2024, in the Korean Intellectual Property Office, the disclosure of which is incorporated by reference herein in its entirety.

### BACKGROUND

One or more example embodiments of the inventive concepts described herein relate to a security policy of a storage controller, and more particularly, relate to a storage controller that assigns a locking domain, a storage device including the same, a system including the storage device, and/or a method of operating the storage device, etc.

A memory device stores data in response to a write request and outputs data stored therein in response to a read request. For example, a memory device classified as a volatile memory device will lose data stored therein when a power supply is turned off, such as a dynamic random access memory (DRAM) device or a static RAM (SRAM) device. A non-volatile memory device is a memory device which retains data stored therein even when a power supply is turned off, such as a flash memory device, a phase-change RAM (PRAM), a magnetic RAM (MRAM), or a resistive RAM (RRAM).

A storage device may include a storage controller and a non-volatile memory device. The storage controller may receive user data from a host device. The storage controller may encrypt the user data by using a media encryption key (MEK). The storage controller may encrypt the media encryption key by using a key encryption key (KEK). The resource burden and complexity of key management for storage devices may be increased by using multiple keys, such as the media encryption key and KEK.

### SUMMARY

One or more example embodiments of the inventive concepts provide a storage controller that assigns a locking domain, a storage device including the same, a system including the storage device, and/or a method of operating the storage device, etc.

According to at least one example embodiment, a storage device includes a storage controller and a non-volatile memory device. The storage controller is configured to, assign a first locking domain for first user data of a first namespace and second user data of a second namespace based on a first assignment request of a host device, generate a first key encryption key (KEK) dedicated to the first locking domain, store first encrypted user data in the non-volatile memory device, the first encrypted user data generated by encrypting the first user data using a first media encryption key (MEK), store second encrypted user data in the non-volatile memory device, the second encrypted user data generated by encrypting the second user data using a second MEK, store a first encrypted MEK in the non-volatile memory device, the first encrypted MEK generated by encrypting the first MEK using the first KEK, store a second encrypted MEK in the non-volatile memory device, the second encrypted MEK generated by encrypting the second MEK using the first KEK, and manage at least part of the first namespace and at least part of the second namespace based on a first encryption policy associated with the first locking domain.

According to at least one example embodiment, a storage controller includes a locking domain table, an assignment manager that assigns a first locking domain for first user data of a first namespace and second user data of a second namespace based on a first assignment request of a host device, and stores first range information of the first locking domain in the locking domain table, and an encryption manager. The encryption manager is configured to, generate a first key encryption key (KEK) dedicated to the first locking domain based on the first range information, generate a first media encryption key (MEK) for encrypting the first user data, store a first encrypted MEK in a non-volatile memory device, the first encrypted MEK generated by encrypting the first MEK using the first KEK, generate a second MEK for encrypting the second user data, store a second encrypted MEK in the non-volatile memory device, the second encrypted MEK generated by encrypting the second MEK using the first KEK, and manage at least part of the first namespace and at least part of the second namespace based on a first encryption policy associated with the first locking domain.

According to at least one example embodiment, a storage controller includes a host device and a non-volatile memory device. A method of operating the storage controller includes receiving a first assignment request from the host device, assigning a first locking domain for first user data of a first namespace and second user data of a second namespace based on the first assignment request, at least part of the first namespace and at least part of the second namespace being managed based on a first encryption policy associated with the first locking domain, generating a first KEK dedicated to the first locking domain, generating a first MEK for encrypting the first user data, storing a first encrypted MEK in the non-volatile memory device, the first encrypted MEK generated by encrypting the first MEK using the first KEK, generating a second MEK for encrypting the second user data, and storing a second encrypted MEK in the non-volatile memory device, the second encrypted MEK generated by encrypting the second MEK using the first KEK.

According to at least one example embodiment, a system may include at least one host device and at least one storage device. The at least one storage device may include at least one non-volatile memory and processing circuitry. The processing circuitry may be configured to, encrypt at least one set of user data using at least one media encryption key (MEK), encrypt the at least one MEK using at least one key encryption key (KEK), and store the encrypted at least one set of user data and the encrypted at least one MEK in at least one locking domain, the at least one KEK assigned to the at least one locking domain.

Some example embodiments provide that the at least one set of user data includes a plurality of sets of user data, the at least one MEK is a plurality of MEKs, and the at least one KEK is a plurality of KEKs, and the processing circuitry is further configured to encrypt the plurality of sets of user data with the plurality of MEKs.

Some example embodiments provide that the processing circuitry is further configured to encrypt two or more of the plurality of MEKs using a single KEK of the plurality of KEKs.

Some example embodiments provide that the processing circuitry is further configured to store the encrypted set of user data in the at least one locking domain corresponding to the KEK used to encrypt the MEK used to encrypt the set of user data.

Some example embodiments provide that the processing circuitry is further configured to encrypt a first MEK and a second MEK using a first KEK, and store the encrypted first MEK and the encrypted second MEK in a first locking domain corresponding to the first KEK.

### BRIEF DESCRIPTION OF THE FIGURES

The above and other objects and features of at least one example embodiment of the inventive concepts will become apparent by describing in detail some example embodiments thereof with reference to the accompanying drawings.

FIG. 1 is a block diagram of an electronic device, according to at least one example embodiment of the inventive concepts.

FIG. 2 is a block diagram illustrating the storage controller of FIG. 1, according to some example embodiments of the inventive concepts.

FIG. 3 is a block diagram for describing the storage controller of FIG. 1, according to some example embodiments of the inventive concepts.

FIG. 4 is a diagram for describing a security policy of a general storage device.

FIG. 5 is a diagram illustrating a security policy of a storage device, according to some example embodiments of the inventive concepts.

FIG. 6 is a diagram illustrating a storage device, according to some example embodiments of the inventive concepts.

FIG. 7 is a diagram for describing a locking domain table, according to some example embodiments of the inventive concepts.

FIG. 8 is a diagram describing a method of operating a storage device, according to some example embodiments of the inventive concepts.

FIG. 9 is a diagram illustrating a security policy of a storage device, according to some example embodiments of the inventive concepts.

FIG. 10 is a flowchart describing a method of operating a storage controller, according to some example embodiments of the inventive concepts.

FIG. 11 is a flowchart describing a method of operating a storage controller, according to some example embodiments of the inventive concepts.

FIG. 12 is a flowchart describing a method of operating a storage controller, according to some example embodiments of the inventive concepts.

### DETAILED DESCRIPTION

Hereinafter, some example embodiments of the inventive concepts will be described in detail and clearly to such an extent that a person of ordinary skill in the art may carry out the inventive concepts.

As used herein, including the claims, each of expressions “A or B”, “at least one of A and B”, “at least one of A or B”, “A, B, or C”, “at least one of A, B, and C”, and “at least one of B or C” may include any of the items listed together in the expressions, or any possible combination thereof.

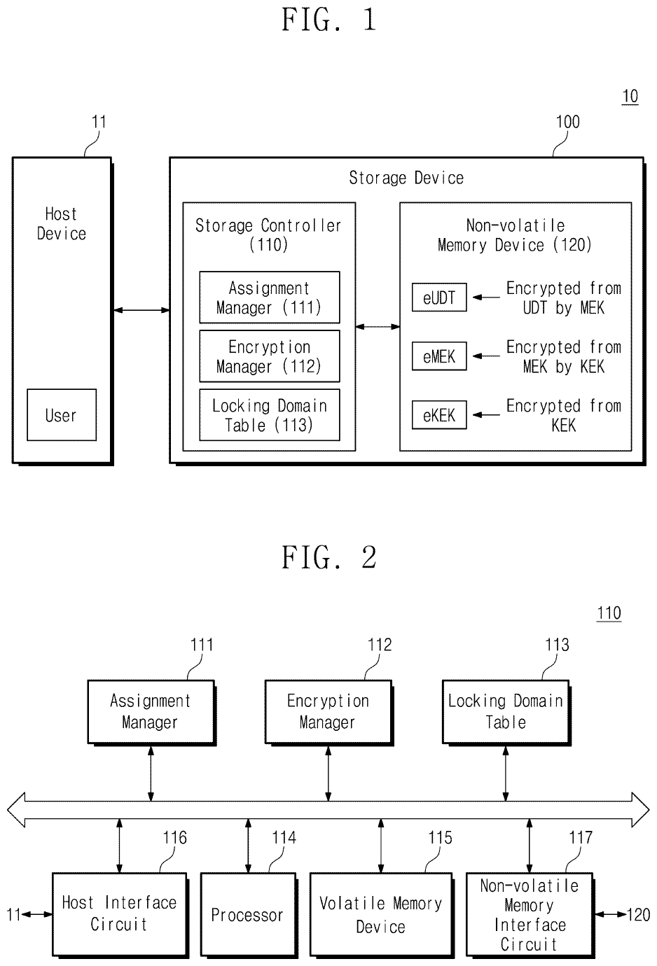

FIG. 1 is a block diagram of an electronic device, according to at least one example embodiment of the inventive concepts. Referring to FIG. 1, an electronic device 10 may include at least one host device 11 and/or at least one storage device 100, but is not limited thereto. The electronic device 10 may be an electronic system configured to process various pieces of information and/or to store the processed information as data. For example, the electronic device 10 may be implemented as a storage system, a server system, a database server, or the like, for managing large amounts of user data. Additionally, or alternatively, the electronic device 10 may be implemented as a computing system, which is configured to process various pieces of information, such as a personal computer (PC), a notebook, a laptop, a server, a workstation, a tablet, a smartphone, a digital camera, an Internet of Things (IoT) device, an autonomous vehicle, a robot, a drone, a virtual reality (VR) device, an augmented reality (AR) device, and/or a mixed reality (MR) device, a gaming console, a camera, or the like.

The host device 11 may control overall operations of the electronic device 10. For example, a user of the host device 11 may assign at least one namespace for managing user data UDT, may manage at least one security policy of the storage device 100, and/or may store the user data UDT in the storage device 100 according to and/or based on the security policy.

A namespace may be referred to as a “logical space” affected by and/or designated by names, such as variables, functions, constants, classes, and the like. Name collisions due to identical names between different namespaces may be reduced and/or prevented. A user may be any entity having permissions to use the host device 11. For example, the user may be implemented with a user application, an operating system (OS), etc.

The storage device 100 may include a storage controller 110 and at least one non-volatile memory device 120, but is not limited thereto, and for example, may also include at least one volatile memory device, etc. The storage device 100 may execute the security policy under the control of the host device 11, may store the user data UDT, may provide the stored user data UDT to the host device 11, and/or may delete the stored user data UDT, etc.

The storage controller 110 (e.g., processing circuitry, etc.) may include an assignment manager 111, an encryption manager 112, and/or a locking domain table 113, etc. Under the control of the host device 11, the storage controller 110 may store data in the non-volatile memory device 120, may provide the stored data to the host device 11, and/or may delete the stored data, etc. According to some example embodiments, the storage controller 110, the assignment manager 111, the encryption manager 112, and/or the locking domain table 113, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The assignment manager 111 may assign a locking domain for the user data UDT of the namespace generated by the host device 11, and may store range information of the locking domain in the locking domain table 113.

A locking domain may be considered as a “range of the logical space” of at least one namespace managed by the same encryption policy. A logical space may be considered as a “range of logical block addresses (LBAs)” for storing the user data UDT of a namespace. In this specification, the encryption policy may be a sub-concept of the security policy and may include rules to determine an encryption method of at least one user data UDT corresponding to the locking domain. The security policy may include encryption policies for multiple locking domains, but is not limited thereto.

In some example embodiments, the locking domain may include all LBAs in a namespace, or may include some of the LBAs (e.g., a subset of the LBAs, at least one LBA, etc.). The locking domain may correspond to a plurality of namespaces.

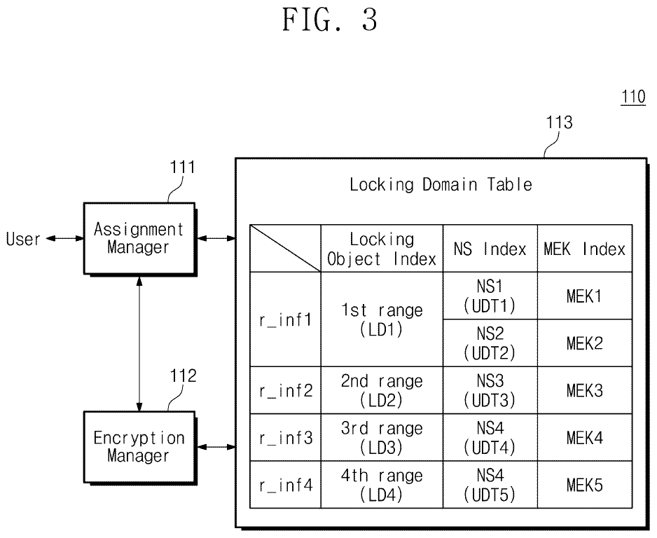

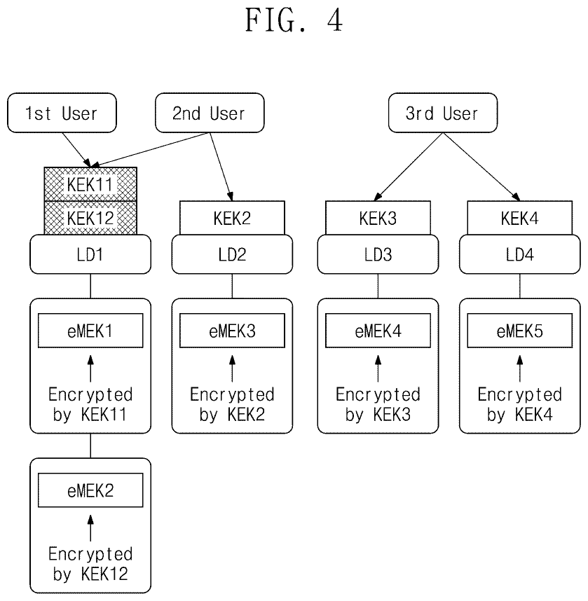

The range information may include various pieces of information about the locking domain. For example, the range information may include locking object index information for identifying a locking object in the locking domain, namespace index information for identifying a namespace, and/or MEK index information for identifying a media encryption key corresponding to all or part of a namespace. Detailed descriptions thereof will be described later with reference to FIG. 3.

The encryption manager 112 may generate at least one media encryption key MEK and/or at least one key encryption key KEK, but is not limited thereto. The encryption manager 112 may receive the user data UDT from the host device 11, may generate encrypted user data eUDT by encrypting the user data UDT by using the media encryption key MEK (e.g., based on the media encryption key MEK), and/or may store the encrypted user data eUDT in the non-volatile memory device 120, etc. The encrypted user data eUDT may also be referred to as “wrapped user data”.

The encryption manager 112 may generate an encrypted media encryption key eMEK by encrypting the media encryption key MEK using the key encryption key KEK, and may store the encrypted media encryption key eMEK in the non-volatile memory device 120. The encrypted media encryption key eMEK may also be referred to as a “wrapped MEK”.

The encryption manager 112 may use an encrypted key encryption key eKEK by encrypting the encryption key KEK based on a security policy, and may store the encrypted key encryption key eKEK in the non-volatile memory device 120. The encrypted key encryption key eKEK may also be referred to as a “wrapped KEK”.

In some example embodiments, the encryption manager 112 may perform a decryption operation based on at least one read request. In more detail, the encryption manager 112 may receive a read request from the host device 11, may decrypt the encrypted key encryption key eKEK based on the security policy, may decrypt the encrypted media encryption key eMEK by using the decrypted key encryption key KEK, may decrypt the encrypted user data eUDT by using the decrypted media encryption key MEK, and may provide the decrypted user data UDT to the host device 11.

The locking domain table 113 may be accessed by and/or modified by the assignment manager 111 and/or the encryption manager 112, etc. The assignment manager 111 may store range information in the locking domain table 113. The assignment manager 111 and/or the encryption manager 112 may refer to range information stored in the locking domain table 113 and/or may update the range information, but are not limited thereto.

In some example embodiments, the assignment manager 111 may additionally create, modify, and/or delete a locking domain, etc. Accordingly, the assignment manager 111 may additionally store the range information in the locking domain table 113, may change the stored range information, and/or may delete the stored range information, etc.

The non-volatile memory device 120 may store data under the control of the storage controller 110. The non-volatile memory device 120 may retain data stored therein even when power to the non-volatile memory device 120 is discontinued and/or interrupted, etc. For example, the non-volatile memory device 120 may be implemented as a NOT-AND (NAND)-based flash memory device, a NOT-OR (NOR)-based flash memory device, a phase-change RAM (PRAM), an magnetic RAM (MRAM), a resistive RAM (RRAM), or the like.

The non-volatile memory device 120 may store encrypted data and/or at least one key, but is not limited thereto. In more detail, the non-volatile memory device 120 may receive the encrypted user data eUDT from the encryption manager 112, and may store the encrypted user data eUDT. The non-volatile memory device 120 may receive the encrypted media encryption key eMEK from the encryption manager 112 and may store the encrypted media encryption key eMEK. The non-volatile memory device 120 may receive the encrypted key encryption key eKEK from the encryption manager 112 and may store the encrypted key encryption key eKEK.

FIG. 2 is a block diagram illustrating the storage controller of FIG. 1, according to some example embodiments of the inventive concepts. Referring to FIGS. 1 and 2, the storage controller 110 (e.g., processing circuitry, etc.) may communicate with the host device 11 and/or the non-volatile memory device 120, but is not limited thereto. The storage controller 110 may include the assignment manager 111, the encryption manager 112, the locking domain table 113, at least one processor 114, at least one volatile memory device 115, at least one host interface circuit 116, and/or at least one non-volatile memory interface circuit 117, etc., but is not limited thereto. The assignment manager 111, the encryption manager 112, and the locking domain table 113 may correspond to the assignment manager 111, the encryption manager 112, and the locking domain table 113 of FIG. 1, respectively. According to some example embodiments, the storage controller 110, the assignment manager 111, the encryption manager 112, the locking domain table 113, the at least one processor 114, the at least one host interface circuit 116, and/or the at least one non-volatile memory interface circuit 117, etc., may be implemented as processing circuitry.

The processor 114 may control overall operations of the storage controller 110. The processor 114 may also be referred to as an “embedded processor” of the storage controller 110. The processor 114 may drive a firmware module by executing instructions loaded onto the volatile memory device 115. The volatile memory device 115 may be implemented as a dynamic random access memory (DRAM), a static RAM (SRAM), or the like. The volatile memory device 115 may function as a buffer memory, a logical-to-physical (L2P) mapping table, and/or a firmware memory, but is not limited thereto. The volatile memory device 115 may buffer (e.g., temporarily store) the user data UDT, the media encryption key MEK, and/or the key encryption key KEK, etc.

At least some of the functions of the assignment manager 111, the encryption manager 112, and/or the locking domain table 113 may be implemented as special purpose software module(s) (e.g., special purpose computer readable instructions for performing one or more of the operations of the methods described herein). For example, the processor 114 may implement at least some of the functions of the assignment manager 111, the encryption manager 112, and/or the locking domain table 113 by loading the computer readable instructions stored as data in the non-volatile memory device 120 onto the volatile memory device 115, and executing the loaded computer readable instructions.

The storage controller 110 may communicate with the host device 11 through the host interface circuit 116. In some example embodiments, the host interface circuit 116 may be implemented based on at least one of various interfaces such as a serial ATA (SATA), a peripheral component interconnect express (PCIe), a serial attached SCSI (SAS), a nonvolatile memory express (NVMe), and/or a universal flash storage (UFS), but is not limited thereto.

The storage controller 110 may communicate with the non-volatile memory device 120 through the non-volatile memory interface circuit 117. In some example embodiments, the non-volatile memory interface circuit 117 may be implemented based on a NAND interface, but is not limited thereto.

FIG. 3 is a block diagram for describing the storage controller of FIG. 1, according to some example embodiments of the inventive concepts. Referring to FIG. 3, the storage controller 110 may include the assignment manager 111, the encryption manager 112, and/or the locking domain table 113, etc., but is not limited thereto.

Under the control of a user, the assignment manager 111 may assign a first locking domain LD1 for a first user data UDT1 of a first namespace NS1 and a second user data UDT2 of a second namespace NS2, etc. The assignment manager 111 may store first range information r_inf1 in the locking domain table 113. The assignment manager 111 may register locking object index information and namespace index information of the first range information r_inf1.

The encryption manager 112 may generate a first media encryption key MEK1 for encrypting the first user data UDT1 based on the communication with the assignment manager 111, may generate a second media encryption key MEK2 for encrypting the second user data UDT2, and may register MEK index information of the first range information r_inf1 of the locking domain table 113.

The first range information r_inf1 may include locking object index information, namespace index information, and/or MEK index information, but is not limited thereto. The locking object index information of the first range information r_inf1 may indicate a first range of addresses corresponding to the first locking domain LD1. The first range may correspond to the entire first namespace NS1 and the entire second namespace NS2, but is not limited thereto. The namespace index information of the first range information r_inf1 may indicate the first namespace NS1 and the second namespace NS2, but is not limited thereto. The MEK index information of the first range information r_inf1 may represent the first and second media encryption keys MEK1 and MEK2, but is not limited thereto.

As in the above description, the assignment manager 111 and the encryption manager 112 may store second range information r_inf2 of a second locking domain LD2 for third user data UDT3 of a third namespace NS3 in the locking domain table 113. The locking object index information of the second range information r_inf2 may indicate a second range of addresses corresponding to the second locking domain LD2. The second range may correspond to the entire third namespace NS3. The namespace index information of the second range information r_inf2 may indicate the third namespace NS3. The MEK index information of the second range information r_inf2 may indicate a third media encryption key MEK3. The third media encryption key MEK3 may be used to encrypt the third user data UDT3.

The assignment manager 111 and the encryption manager 112 may store third range information r_inf3 of a third locking domain LD3 for fourth user data UDT4 of a fourth namespace NS4 in the locking domain table 113. The locking object index information of the third range information r_inf3 may indicate a third range of addresses corresponding to the third locking domain LD3. The third range may correspond to a part of the fourth namespace NS4. The namespace index information of the third range information r_inf3 may indicate the fourth namespace NS4. The MEK index information of the third range information r_inf3 may indicate a fourth media encryption key MEK4. The fourth media encryption key MEK4 may be used to encrypt the fourth user data UDT4.

The assignment manager 111 and the encryption manager 112 may store fourth range information r_inf4 of a fourth locking domain LD4 for fifth user data UDT5 of the fourth namespace NS4 in the locking domain table 113. The locking object index information of the fourth range information r_inf4 may indicate a fourth range of addresses corresponding to the fourth locking domain LD4. The fourth range may correspond to other parts of the fourth namespace NS4 (e.g., other parts different from the third range). The namespace index information of the fourth range information r_inf4 may indicate the fourth namespace NS4. The MEK index information of the fourth range information r_inf4 may indicate a fifth media encryption key MEK5. The fifth media encryption key MEK5 may be used to encrypt the fifth user data UDT5.

As described above, according to one or more example embodiments of the inventive concepts, the assignment manager 111 and the encryption manager 112 may generate range information of a locking domain. The locking domain may correspond to two or more namespaces, may correspond to a single namespace, or may correspond to a part of a single namespace. A media encryption key corresponding to all or part of a namespace may be used. At least one media encryption key may be used in the locking domain.

FIG. 4 is a diagram for describing a security policy of a general storage device. Referring to FIG. 4, a security policy for managing locking domains of a general storage device is described. To help in the understanding of at least one example embodiment of the inventive concepts, a general storage device is described. However, the general storage device may include features not disclosed in the prior art, and is not intended to limit the scope of the example embodiments of the inventive concepts.

The general storage device may assign a plurality of locking domains, e.g., the first to fourth locking domains LD1 to LD4, etc., but is not limited thereto. A first user may have access to the first locking domain LD1. A second user may have permission to access the first and second locking domains LD1 and LD2. A third user may have permission to access the third and fourth locking domains LD3 and LD4. However, the example embodiments are not limited thereto, and there may be any number of users and/or locking domains, and each of the users may have access to any number of locking domains.

In the first locking domain LD1, the first and second media encryption keys MEK1 and MEK2 and key encryption keys KEK11 and KEK12 may be used, but the example embodiments are not limited thereto. The general storage device may generate a first encrypted media encryption key eMEK1 by encrypting the first media encryption key MEK1 using the key encryption key KEK11, but is not limited thereto. The general storage device may generate a second encrypted media encryption key eMEK2 by encrypting the second media encryption key MEK2 using the key encryption key KEK12, but is not limited thereto.

The third media encryption key MEK3 and a second key encryption key KEK2 may be used in the second locking domain LD2, but the example embodiments are not limited thereto. The general storage device may generate a third encrypted media encryption key eMEK3 by encrypting the third media encryption key MEK3 using the second key encryption key KEK2, but is not limited thereto.

The fourth media encryption key MEK4 and a third key encryption key KEK3 may be used in the third locking domain LD3, but the example embodiments are not limited thereto. The general storage device may generate a fourth encrypted media encryption key eMEK4 by encrypting the fourth media encryption key MEK4 by using the third key encryption key KEK3, but is not limited thereto.

The fifth media encryption key MEK5 and a fourth key encryption key KEK4 may be used in the fourth locking domain LD4, but the example embodiments are not limited thereto. The general storage device may generate a fifth encrypted media encryption key eMEK5 by encrypting the fifth media encryption key MEK5 by using the fourth key encryption key KEK4, but is not limited thereto.

As described above, according to and/or based on the security policy of the general storage device, a key encryption key may be assigned to each media encryption key. When a plurality of media encryption keys are used within a locking domain, different key encryption keys are used for each of a plurality of media encryption keys even though the encryption policy applied to the plurality of media encryption keys is the same, thereby increasing the resource burden and/or complexity for key management. The resource may include computational resources and storage resources of metadata corresponding to a key encryption key and a media encryption key.

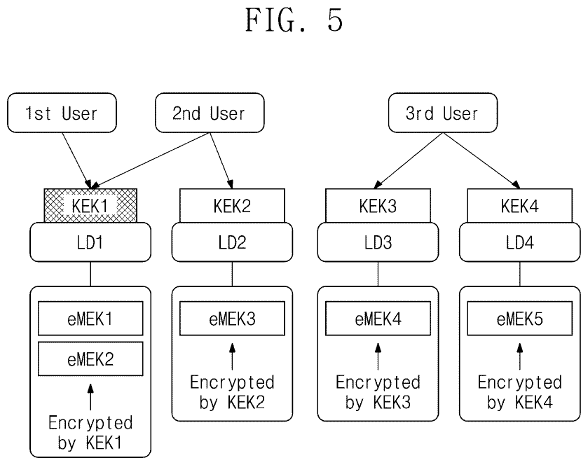

FIG. 5 is a diagram illustrating a security policy of a storage device, according to some example embodiments of the inventive concepts. Referring to FIGS. 1, 3, and 5, a security policy for managing locking domains of the storage device 100 according to some example embodiments of the inventive concepts is described.

The storage device 100 may assign a plurality of locking domains, e.g., the first to fourth locking domains LD1 to LD4, etc. A first user may have access to the first locking domain LD1, etc. A second user may have permission to access the first and second locking domains LD1 and LD2, etc. A third user may have permission to access the third and fourth locking domains LD3 and LD4, etc.

The first media encryption key MEK1 for encrypting the first user data UDT1 of the first namespace NS1 and the second media encryption key MEK2 for encrypting the second user data UDT2 of the second namespace NS2 may be used in the first locking domain LD1, but the example embodiments are not limited thereto. The storage device 100 may generate a first key encryption key KEK1 dedicated to the first locking domain LD1, but is not limited thereto.

The storage device 100 may generate the first encrypted media encryption key eMEK1 by encrypting the first media encryption key MEK1 using the first key encryption key KEK1. The storage device 100 may generate the second encrypted media encryption key eMEK2 by encrypting the second media encryption key MEK2 using the first key encryption key KEK1. In other words, the first key encryption key KEK1 may be compatible with both the first and second media encryption keys MEK1 and MEK2, etc.

The third media encryption key MEK3 for encrypting the third user data UDT3 of the third namespace NS3 may be used in the second locking domain LD2, but is not limited thereto. The storage device 100 may generate the second key encryption key KEK2 dedicated to the second locking domain LD2. The storage device 100 may generate the third encrypted media encryption key eMEK3 by encrypting the third media encryption key MEK3 using the second key encryption key KEK2.

The fourth media encryption key MEK4 for encrypting the fourth user data UDT4 of the fourth namespace NS4 may be used in the third locking domain LD3, but is not limited thereto. The storage device 100 may generate the third key encryption key KEK3 dedicated to the third locking domain LD3. The storage device 100 may generate the fourth encrypted media encryption key eMEK4 by encrypting the fourth media encryption key MEK4 using the third key encryption key KEK3.

The fifth media encryption key MEK5 for encrypting the fifth user data UDT5 of the fourth namespace NS4 may be used in the fourth locking domain LD4, but is not limited thereto. The storage device 100 may generate the fourth key encryption key KEK4 dedicated to the fourth locking domain LD4. The storage device 100 may generate the fifth encrypted media encryption key eMEK5 by encrypting the fifth media encryption key MEK5 using the fourth key encryption key KEK4.

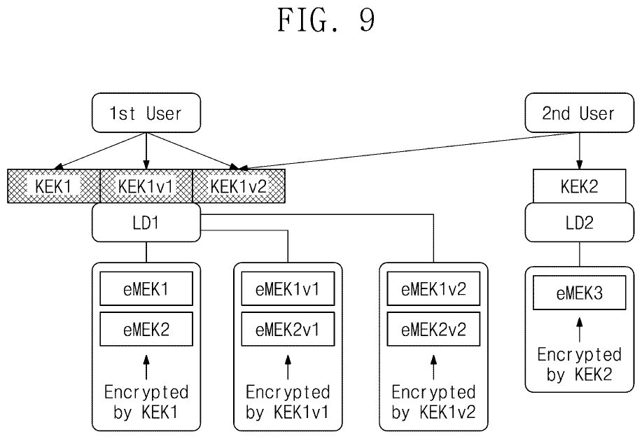

As described above, according to the security policy of the storage device 100 of one or more example embodiments of the inventive concepts, the key encryption key may be assigned in units of locking domains, not in units of media encryption keys. The key encryption key dedicated to a locking domain is compatible between a plurality of namespaces of the locking domain, thereby reducing the resource burden and/or complexity of key management. Moreover, a key rotation operation becomes easier and/or more efficient, and thus the security and/or recoverability of user data may be increased. A more detailed description of a key rotation operation will be described later with reference to FIGS. 8 and 9.

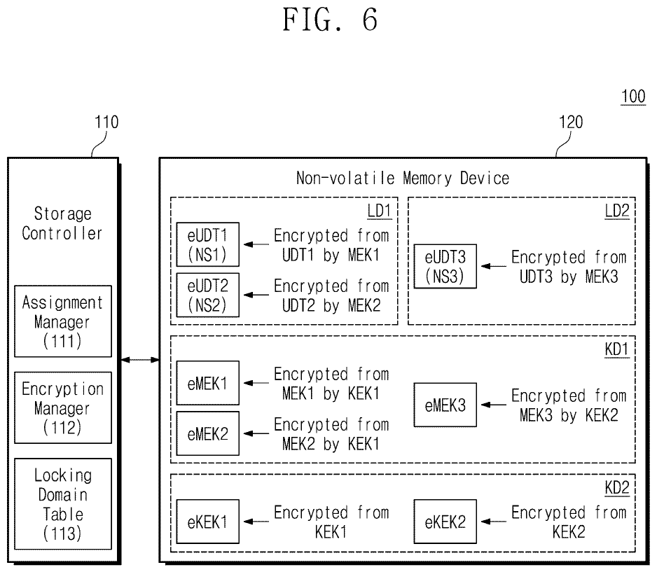

FIG. 6 is a diagram illustrating a storage device, according to some example embodiments of the inventive concepts. Referring to FIG. 6, the storage device 100 may include the storage controller 110 and the non-volatile memory device 120, but is not limited thereto.

The storage controller 110 may include the assignment manager 111, the encryption manager 112, and/or the locking domain table 113, etc. The non-volatile memory device 120 may include physical storage areas for the first locking domain LD1, the second locking domain LD2, a first key domain KD1, and/or a second key domain KD2, but the example embodiments are not limited thereto.

The first locking domain LD1, the second locking domain LD2, the first key domain KD1, and the second key domain KD2 may be referred to as “logical areas” identified by the storage controller 110 and may correspond to physical storage areas of the non-volatile memory device 120.

The physical storage area corresponding to the first locking domain LD1 may store one or more encrypted user data, such as a first encrypted user data eUDT1 and/or a second encrypted user data eUDT2, etc., but is not limited thereto. The physical storage area corresponding to the second locking domain LD2 may store a third encrypted user data eUDT3. The physical storage area corresponding to the first key domain KD1 may store the first encrypted media encryption key eMEK1, the second encrypted media encryption key eMEK2, and the third encrypted media encryption key eMEK3, or in other words, the physical storage area corresponding to the first key domain KD1 may store one or more encryption keys associated with the encrypted user data stored in the first key domain KD1, etc. The physical storage area corresponding to the second key domain KD2 may store a first encrypted key encryption key eKEK1 and a second encrypted key encryption key eKEK2, etc.

The assignment manager 111 may assign and/or allocate the first locking domain LD1 for the first user data UDT1 of the first namespace NS1 and the second user data UDT2 of the second namespace NS2 based on a first allocation request of the host device 11 of FIG. 1, or in other words, the first allocation request may include instructions and/or otherwise indicate the assignment and/or allocation of a locking domain for the user data stored in each of the namespaces, etc. At least part of the first namespace NS1 and at least part of the second namespace NS2 may be managed according to the first encryption policy of the first locking domain LD1. A locking domain may be referred to as a “range of at least one namespace” managed according to the same encryption policy. The assignment manager 111 may store first range information of the first locking domain LD1 in the locking domain table 113.

In some example embodiments, the first locking domain LD1 may be referred to as a “global range of a locking object of Trusted Computing Group (TCG) Opal standard,” but the example embodiments are not limited thereto.

In some example embodiments, the first locking domain LD1 may correspond to the entire first namespace NS1, but is not limited thereto. For example, all LBAs in the first namespace NS1 may be assigned for the first user data UDT1. The first locking domain LD1 may include all LBAs of the first namespace NS1, but is not limited thereto.

In some example embodiments, the first locking domain LD1 may correspond to a part (e.g., a subset) of the first namespace NS1. For example, some LBAs among all LBAs of the first namespace NS1 may be assigned for the first user data UDT1. The first locking domain LD1 may include some LBAs corresponding to the first user data UDT1 among all LBAs of the first namespace NS1.

The encryption manager 112 may refer to the first range information (e.g., first address range information, etc.) of the first locking domain LD1 stored in the locking domain table 113. The encryption manager 112 may generate the first key encryption key KEK1 dedicated to the first locking domain LD1. The encryption manager 112 may generate the first media encryption key MEK1 for encrypting the first user data UDT1. The encryption manager 112 may generate the second media encryption key MEK2 for encrypting the second user data UDT2.

The encryption manager 112 may store the first encrypted user data eUDT1 generated by encrypting the first user data UDT1 using the first media encryption key MEK1 in the non-volatile memory device 120. The encryption manager 112 may store the second encrypted user data eUDT2 generated by encrypting the second user data UDT2 using the second media encryption key MEK2 in the non-volatile memory device 120.

The encryption manager 112 may store the first encrypted media encryption key eMEK1 generated by encrypting the first media encryption key MEK1 using the first key encryption key KEK1 in the non-volatile memory device 120. The encryption manager 112 may store the second encrypted media encryption key eMEK2 generated by encrypting the second media encryption key MEK2 using the first key encryption key KEK1 in the non-volatile memory device 120.

The encryption manager 112 may store the first encrypted key encryption key eKEK1 generated by encrypting the first key encryption key KEK1 in the non-volatile memory device 120. For example, the encryption manager 112 may encrypt the first key encryption key KEK1 according to and/or based on the security policy.

In some example embodiments, the first encryption policy of the first locking domain LD1 may determine the permission to access the first encrypted key encryption key eKEK1. For example, the encryption manager 112 may set a lock enabled value of the first locking domain LD1 to a first Boolean value or a second Boolean value. The first Boolean value may be a true value. The second Boolean value may be a false value. The encryption manager 112 may block access to the first encrypted key encryption key eKEK1 while the lock enabled value is set to the first Boolean value. The encryption manager 112 may allow access to the first encrypted key encryption key eKEK1 while the lock enabled value is set to the second Boolean value.

The assignment manager 111 may assign the second locking domain LD2 for the third user data UDT3 of the third namespace NS3 based on a second allocation request of the host device 11 of FIG. 1. At least part of the third namespace NS3 may be managed according to and/or based on the second encryption policy of the second locking domain LD2. The assignment manager 111 may store the second range information (e.g., second address range information) of the second locking domain LD2 in the locking domain table 113.

The encryption manager 112 may refer to second range information of the second locking domain LD2 stored in the locking domain table 113. The encryption manager 112 may generate the second key encryption key KEK2 dedicated to the second locking domain LD2. The encryption manager 112 may generate the third media encryption key MEK3 for encrypting the third user data UDT3.

The encryption manager 112 may store the third encrypted user data eUDT3 generated by encrypting the third user data UDT3 using the third media encryption key MEK3 in the non-volatile memory device 120.

The encryption manager 112 may store the third encrypted media encryption key eMEK3 generated by encrypting the third media encryption key MEK3 using the second key encryption key KEK2 in the non-volatile memory device 120.

The encryption manager 112 may store the second encrypted key encryption key eKEK2 generated by encrypting the second key encryption key KEK2 in the non-volatile memory device 120. For example, the encryption manager 112 may encrypt the second key encryption key KEK2 according to and/or based on the security policy.

In some example embodiments, the assignment manager 111 may assign the first locking domain LD1 corresponding to three or more namespaces, but the example embodiments are not limited thereto. For example, unlike the illustration of FIG. 6, the assignment manager 111 may assign the first locking domain LD1 for the first user data UDT1 of the first namespace NS1, the second user data UDT2 of the second namespace NS2, and the fourth user data of the fourth namespace based on the assignment request of the host device 11 of FIG. 1, etc. The assignment manager 111 may store first range information (e.g., first address range information, etc.) of the first locking domain LD1 in the locking domain table 113.

The encryption manager 112 may refer to and/or look up the first range information of the first locking domain LD1 stored in the locking domain table 113. The encryption manager 112 may generate a fourth media encryption key for encrypting the fourth user data. The encryption manager 112 may store the fourth encrypted user data generated by encrypting the fourth user data using the fourth media encryption key in the non-volatile memory device 120. The encryption manager 112 may store the fourth encrypted media encryption key generated by encrypting the fourth media encryption key using the first key encryption key KEK1 in the non-volatile memory device 120. At this time, at least part of the first namespace NS1, at least part of the second namespace NS2, and at least part of the fourth namespace may be managed according to and/or based on the first encryption policy of the first locking domain LD1, but the example embodiments are not limited thereto.

In some example embodiments, the assignment manager 111 may assign and/or allocate a locking domain corresponding to a portion of the namespace. For example, the first part (e.g., first LBAs, a first subset of LBAs) of all LBAs of the third namespace NS3 may correspond to the third user data UDT3, and the second part (e.g., second LBAs, a second subset of LBAs) of all LBAs thereof may correspond to the fifth user data. Among all LBAs of the third namespace NS3, the first part corresponding to the third user data UDT3 may be managed according to and/or based on the second encryption policy of the second locking domain LD2.

Unlike the illustration of FIG. 6, the assignment manager 111 may further assign a third locking domain for the fifth user data of the third namespace NS3 based on the assignment request of the host device 11 of FIG. 1. The assignment manager 111 may store third range information (e.g., third address range information, etc.) of the third locking domain in the locking domain table 113.

The encryption manager 112 may refer to and/or look up the third range information of the third locking domain stored in the locking domain table 113. The encryption manager 112 may generate a third key encryption key dedicated to the third locking domain. The encryption manager 112 may generate a fifth media encryption key for encrypting the fifth user data. The encryption manager 112 may store the fifth encrypted user data generated by encrypting the fifth user data using the fifth media encryption key in the non-volatile memory device 120.

The encryption manager 112 may store the fifth encrypted media encryption key generated by encrypting the fifth media encryption key using the third key encryption key in the non-volatile memory device 120. The encryption manager 112 may store the third encrypted key encryption key generated by encrypting the third key encryption key according to and/or based on the security policy in the non-volatile memory device 120. At this time, the second part corresponding to the fifth user data among all LBAs of the third namespace NS3 may be managed according to and/or based on the third encryption policy of the third locking domain.

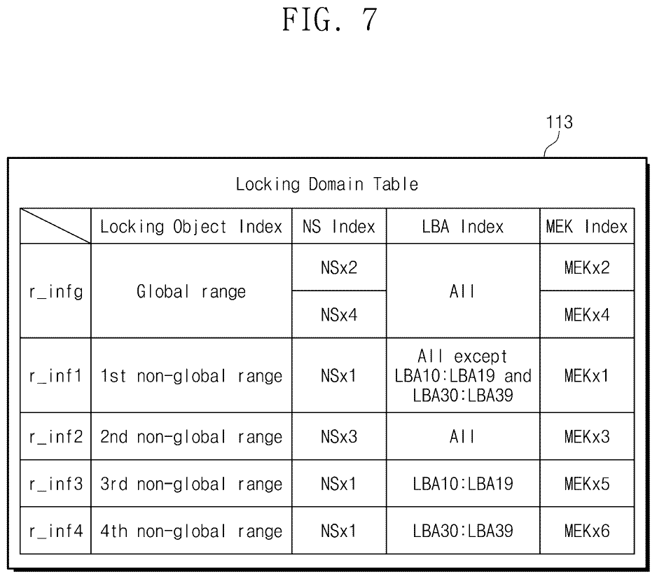

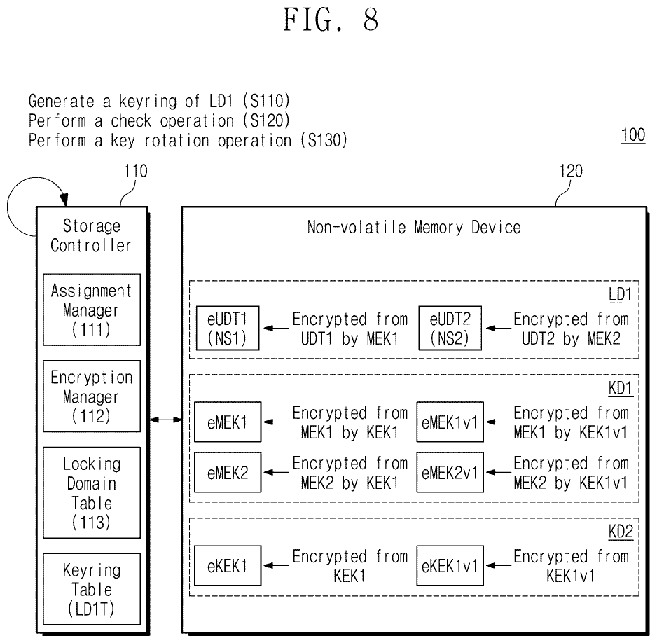

FIG. 7 is a diagram for describing a locking domain table, according to some example embodiments of the inventive concepts. Referring to FIG. 7, the locking domain table 113 may be implemented based on a TCG Opal standard, but the example embodiments are not limited thereto. The locking domain table 113 may store locking object index information, namespace index information, LBA index information, and/or MEK index information of global range information r_infg and each of the first to fourth range information r_inf1 to r_inf4, etc., but the example embodiments are not limited thereto.

The global range information r_infg may be unique in the locking domain table 113. The global range information r_infg may correspond to a plurality of namespaces. The global range information r_infg may be referred to as a “global range” of the locking object of the TCG Opal standard. The global range may also be referred to as a “locking domain”.

For example, the locking object index information of the global range information r_infg may indicate the global range (e.g., the locking domain). Namespace index information of the global range information r_infg may indicate namespaces NSx2 and NSx4, but is not limited thereto. LBA index information of the global range information r_infg may indicate the entire namespace NSx2 and the entire namespace NSx4, etc. MEK index information of the global range information r_infg may indicate media encryption keys MEKx2 and MEKx4, but is not limited thereto. The media encryption key MEKx2 may correspond to the entire namespace NSx2. The media encryption key MEKx4 may correspond to the entire namespace NSx4.

The first to fourth range information r_inf1 to r_inf4 may be referred to as the “first to fourth non-global ranges of the locking object of the TCG Opal standard”. The non-global range may also be referred to as a “locking domain”. The TCG Opal standard may allow the plurality of non-global ranges in the locking domain table 113. A piece of non-global range information may correspond to all or part of a namespace.

For example, the locking object index information of the first range information r_inf1 may indicate a first non-global range (e.g., the first locking domain). Namespace index information of the first range information r_inf1 may indicate a namespace NSx1. LBA index information of the first range information r_inf1 may indicate the rest of the entire LBAs of the namespace NSx1 other than the tenth to nineteenth LBAs LBA10 to LBA19 and the 30^{th} to 39^{th} LBAs LBA30 to LBA39, etc. MEK index information of the first range information r_inf1 may indicate a media encryption key MEKx1. The media encryption key MEKx1 may correspond to the rest of all LBAs of the namespace NSx1 other than the tenth to nineteenth LBAs LBA10 to LBA19 and the 30th to 39th LBAs LBA30 to LBA39, etc.

The locking object index information of the second range information r_inf2 may indicate the second non-global range (e.g., the second locking domain). Namespace index information of the second range information r_inf2 may indicate a namespace NSx3. LBA index information of the second range information r_inf2 may indicate the entire namespace NSx3. MEK index information of the second range information r_inf2 may indicate a media encryption key MEKx3. The media encryption key MEKx3 may correspond to the entire namespace NSx3.

Locking object index information of the third range information r_inf3 may indicate the third non-global range (e.g., the third locking domain). Namespace index information of the third range information r_inf3 may indicate the namespace NSx1. LBA index information of the third range information r_inf3 may indicate the tenth to nineteenth LBAs LBA10 to LBA19. MEK index information of the third range information r_inf3 may indicate a media encryption key MEKx5. The media encryption key MEKx5 may correspond to the tenth to nineteenth LBAs LBA10 to LBA19 of all LBAs of the namespace NSx1.

Locking object index information of the fourth range information r_inf4 may indicate the fourth non-global range (e.g., the fourth locking domain). Namespace index information of the fourth range information r_inf4 may indicate the namespace NSx1. LBA index information of the fourth range information r_inf4 may indicate the 30th to 39th LBAs LBA30 to LBA39. MEK index information of the fourth range information r_inf4 may indicate a media encryption key MEKx6. The media encryption key MEKx6 may correspond to the 30th to 39th LBAs LBA30 to LBA39 of all LBAs of the namespace NSx1.

FIG. 8 is a diagram describing a method of operating a storage device, according to some example embodiments of the inventive concepts. Referring to FIG. 8, the storage device 100 may include the storage controller 110 and the non-volatile memory device 120, but is not limited thereto.

The storage controller 110 may include the assignment manager 111, the encryption manager 112, the locking domain table 113, and/or a keyring table LD1T, etc., but is not limited thereto. The keyring table LD1T may store the details (e.g., identification information, version information, and/or activation status information of each key, etc.) of a keyring composed of and/or including a plurality of key encryption rings, e.g., key encryption keys KEK1 and KEK1v1, etc., dedicated to the first locking domain LD1. The keyring may be referred to as a “set of key encryption keys” of different versions dedicated to the same locking domain. The first key encryption key KEK1 may also be referred to as a default version key encryption key KEK1v0. The first version key encryption key KEK1v1 may be a subsequent version of the first key encryption key KEK1, etc.

For example, the keyring may include the first key encryption key KEK1 and the first version key encryption key KEK1v1, but is not limited thereto. The encryption manager 112 may store identification information, version information, and/or activation status information, etc., of the first key encryption key KEK1 in the keyring table LD1T. The encryption manager 112 may store identification information, version information, and/or activation status information, etc., of the first version key encryption key KEK1v1 in the keyring table LD1T. The identification information may be used to distinguish between different versions of keys. The version information may indicate the version of a key. The activation status information may indicate whether the corresponding key is activated.

The non-volatile memory device 120 may include physical storage areas for the first locking domain LD1, the second locking domain LD2, the first key domain KD1, and/or the second key domain KD2, but is not limited thereto.

Hereinafter, a method of generating and managing the keyring of the storage device 100 after the first locking domain LD1 for the first user data UDT1 of the first namespace NS1 and the second user data UDT2 of the second namespace NS2 is assigned, the first and second media encryption keys MEK1 and MEK2 for the first and second user data UDT1 and UDT2 are generated, and the first key encryption key KEK1 dedicated to the first locking domain LD1 is generated is described, but the example embodiments are not limited thereto.

In operation S110, the storage controller 110 may generate a keyring of the first locking domain LD1. In more detail, the encryption manager 112 may generate the first version key encryption key KEK1v1 dedicated to the first locking domain LD1 based on a keyring generation request. The keyring generation request may be received from the host device 11 of FIG. 1, or may be generated internally in the storage controller 110 according to and/or based on a security policy.

The encryption manager 112 may read out the first encrypted media encryption key eMEK1 from the non-volatile memory device 120, may generate the first media encryption key MEK1 by decrypting the first encrypted media encryption key eMEK1 using the first key encryption key KEK1, and may store a first re-encrypted media encryption key eMEK1v1 generated by re-encrypting the first media encryption key MEK1 using the first version key encryption key KEK1v1 in the non-volatile memory device 120, but the example embodiments are not limited thereto.

Similarly, the encryption manager 112 may read out the second encrypted media encryption key eMEK2 from the non-volatile memory device 120, may generate the second media encryption key MEK2 by decrypting the second encrypted media encryption key eMEK2 using the first key encryption key KEK1, and may store a second re-encrypted media encryption key eMEK2v1 generated by re-encrypting the second media encryption key MEK2 using the first version key encryption key KEK1v1 in the non-volatile memory device 120, but the example embodiments are not limited thereto.

After storing the first and second re-encrypted media encryption keys eMEK1v1 and eMEK2v1 in the non-volatile memory device 120, the encryption manager 112 may register the first key encryption key KEK1 and the first version key encryption key KEK1v1 in the keyring table LD1T (e.g., storing keyring details of each of the key encryption keys associated with the locking domain, etc.). For example, the encryption manager 112 may store the version information and the activation status information of the first key encryption key KEK1 in the keyring table LD1T, and may store the version information and the activation status information of the first version key encryption key KEK1v1 in the keyring table LD1T, etc.

The encryption manager 112 may encrypt the first key encryption key KEK1 and the first version key encryption key KEK1v1 according to and/or based on the security policy, and may store the first encrypted key encryption key eKEK1 and a first version encrypted key encryption key eKEK1v1 in the non-volatile memory device 120, etc.

In operation S120, the storage controller 110 may perform a check operation. For example, the storage controller 110 may check the version information and/or activation status information of the first key encryption key KEK1 with reference to the keyring table LD1T. For another example, the storage controller 110 may receive a check request of the first key encryption key KEK1 from the host device 11 of FIG. 1, and may provide the version information and/or the activation status information of the first key encryption key KEK1 to the host device 11 with reference to the keyring table LD1T based on the check request.

In operation S130, the storage controller 110 may perform a key rotation operation of the first locking domain LD1 based on a key rotation request. The key rotation operations may be performed after the keyring is generated. The key rotation operation may be referred to as the rotation of a key encryption key used in the locking domain.

For example, the key rotation operation may include at least one of generating a second version key encryption key KEK1v2 (e.g., a subsequent version of the first version key encryption key KEK1v1) dedicated to the first locking domain LD1 and registering the second version key encryption key KEK1v2 in the keyring table LD1T, deleting the first key encryption key KEK1 or the first version key encryption key KEK1v1, deactivating the first key encryption key KEK1 or the first version key encryption key KEK1v1, and activating the first key encryption key KEK1 or the first version key encryption key KEK1v1. The storage controller 110 may newly register or update the version information and/or the activation status information of the keyring table LD1T based on the key rotation operation, but the example embodiments are not limited thereto.

In some example embodiments, the key rotation request may be performed automatically and/or manually. For example, the storage controller 110 may receive a key rotation request from the host device 11 of FIG. 1, and may manually perform a key rotation operation. For another example, the storage controller 110 may periodically generate a key rotation request based on a security policy, and may automatically perform the key rotation operation.

FIG. 9 is a diagram illustrating a security policy of a storage device, according to some example embodiments of the inventive concepts. Referring to FIGS. 8 and 9, a security policy for managing a keyring of the storage device 100 according to some example embodiments of the inventive concepts is described. The storage device 100 may include the storage controller 110, but is not limited thereto.

The storage controller 110 may assign the first locking domain LD1 for the first user data UDT1 and the second user data UDT2, etc. The storage controller 110 may generate the first and second media encryption keys MEK1 and MEK2 for respectively encrypting the first and second user data UDT1 and UDT2, etc. The storage controller 110 may generate the first key encryption key KEK1 dedicated to the first locking domain LD1. The storage controller 110 may generate the first and second encrypted media encryption keys eMEK1 and eMEK2 by encrypting the first and second media encryption keys MEK1 and MEK2 using the first key encryption key KEK1, but the example embodiments are not limited thereto.

The storage controller 110 may generate the first version key encryption key KEK1v1 and the second version key encryption key KEK1v2, which are dedicated to the first locking domain LD1, by generating a keyring or performing a key rotation operation, etc. The storage controller 110 may generate the first and second re-encrypted media encryption keys eMEK1v1 and eMEK2v1 by encrypting the first and second media encryption keys MEK1 and MEK2 using the first version key encryption key KEK1v1. The storage controller 110 may generate the first and second re-encrypted media encryption keys eMEK1v2 and eMEK2v2 by encrypting the first and second media encryption keys MEK1 and MEK2 using the second version key encryption key KEK1v2. The first key encryption key KEK1, the first version key encryption key KEK1v1, and the second version key encryption key KEK1v2 may collectively be referred to as a “keyring of the first locking domain LD1,” but the example embodiments are not limited thereto.

In this case, the first key encryption key KEK1 is generated in units of locking domains, not in units of media encryption keys, thereby reducing the management burden of the first key encryption key KEK1. Because of low resource burden and/or low complexity for key management, the storage controller 110 may more easily and/or more quickly generate a keyring and/or may easily perform a key rotation operation. A key encryption key changes through a key rotation operation, thereby improving the security of user data. Even when some key encryption keys are unavailable, a key encryption key having another version may be used, thereby increasing the possibility of restoring user data.

The storage controller 110 may assign the second locking domain LD2 for the third user data UDT3. The storage controller 110 may generate the third media encryption key MEK3 for encrypting the third user data UDT3. The storage controller 110 may generate the second key encryption key KEK2 dedicated to the second locking domain LD2. The storage controller 110 may generate the third encrypted media encryption key eMEK3 by encrypting the third media encryption key MEK3 using the second key encryption key KEK2.

A first user may have permission to access the first key encryption key KEK1, the first version key encryption key KEK1v1, and the second version key encryption key KEK1v2. A second user may have permission to access the second version key encryption key KEK1v2.

In some example embodiments, the storage controller 110 may automatically perform the key rotation operation based on the addition, removal, and/or change of users, but the example embodiments are not limited thereto.

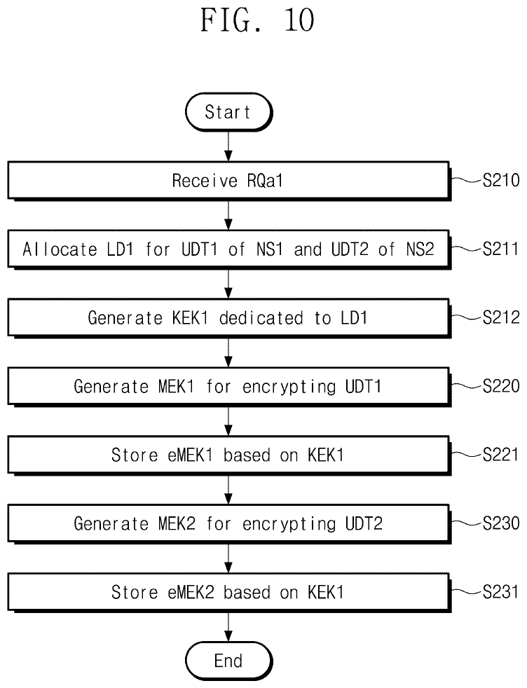

FIG. 10 is a flowchart describing a method of operating a storage controller, according to some example embodiments of the inventive concepts. Referring to FIG. 10, the storage controller may communicate with a host device and a non-volatile memory device, but is not limited thereto.

In operation S210, the storage controller may receive a first assignment request RQa1 from the host device.

In operation S211, the storage controller may allocate and/or assign the first locking domain LD1 for the first user data UDT1 of the first namespace NS1 and the second user data UDT2 of the second namespace NS2 based on the first assignment request RQa1, but is not limited thereto. At least part of the first namespace NS1 and at least part of the second namespace NS2 may be managed according to and/or based on the first encryption policy of the first locking domain LD1.

In operation S212, the storage controller may generate the first key encryption key KEK1 dedicated to the first locking domain LD1.

In operation S220, the storage controller may generate the first media encryption key MEK1 for encrypting the first user data UDT1.

In operation S221, the storage controller may store the first encrypted media encryption key eMEK1 generated by encrypting the first media encryption key MEK1 using the first key encryption key KEK1 in the non-volatile memory device.

In operation S230, the storage controller may generate the second media encryption key MEK2 for encrypting the second user data UDT2.

In operation S231, the storage controller may store the second encrypted media encryption key eMEK2 generated by encrypting the second media encryption key MEK2 using the first key encryption key KEK1 in the non-volatile memory device.

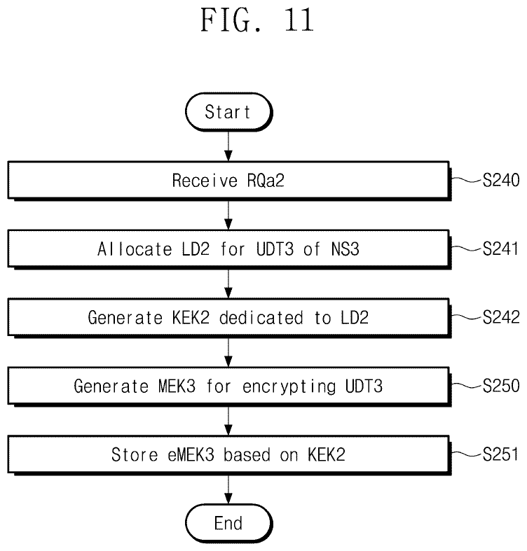

FIG. 11 is a flowchart describing a method of operating a storage controller, according to some example embodiments of the inventive concepts. Referring to FIG. 11, the storage controller may communicate with a host device and a non-volatile memory device. In some example embodiments, the storage controller may perform both the method of FIG. 10 and the method of FIG. 11, but the example embodiments are not limited thereto.

In operation S240, the storage controller may receive a second assignment request RQa2 from the host device.

In operation S241, the storage controller may allocate the second locking domain LD2 for the third user data UDT3 of the third namespace NS3 based on the second assignment request RQa2. At least part of the third namespace NS3 may be managed according to and/or based on the second encryption policy of the second locking domain LD2.

In operation S242, the storage controller may generate the second key encryption key KEK2 dedicated to the second locking domain LD2.

In operation S250, the storage controller may generate the third media encryption key MEK3 for encrypting the third user data UDT3.

In operation S251, the storage controller may store the third encrypted media encryption key eMEK3 generated by encrypting the third media encryption key MEK3 using the second key encryption key KEK2 in the non-volatile memory device.

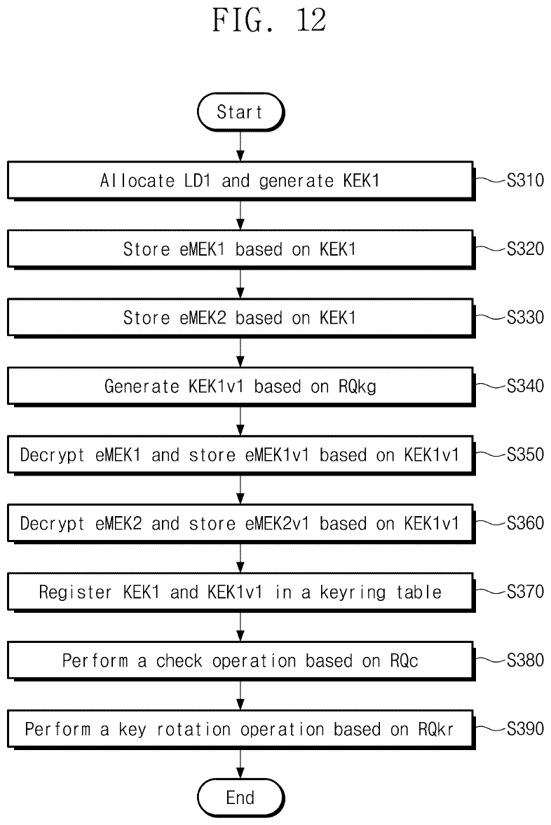

FIG. 12 is a flowchart describing a method of operating a storage controller, according to some example embodiments of the inventive concepts. Referring to FIG. 12, the storage controller may communicate with a host device and a non-volatile memory device. Operation S310 may correspond to operation S210, operation S211, and operation S222 of FIG. 10. Operation S320 may correspond to operation S220 and operation S221 of FIG. 10. Operation S330 may correspond to operation S230 and operation S231 of FIG. 10.

In operation S310, the storage controller may allocate and/or assign the first locking domain LD1 for the first user data UDT1 of the first namespace NS1 and the second user data UDT2 of the second namespace NS2, but is not limited thereto. The storage controller may generate the first key encryption key KEK1 dedicated to the first locking domain LD1.

In operation S320, the storage controller may generate the first media encryption key MEK1 for encrypting the first user data UDT1. The storage controller may store the first encrypted media encryption key eMEK1 generated by encrypting the first media encryption key MEK1 using the first key encryption key KEK1 in the non-volatile memory device.

In operation S330, the storage controller may generate the second media encryption key MEK2 for encrypting the second user data UDT2. The storage controller may store the second encrypted media encryption key eMEK2 generated by encrypting the second media encryption key MEK2 using the first key encryption key KEK1 in the non-volatile memory device.

In operation S340, the storage controller may generate the first version key encryption key KEK1v1 dedicated to the first locking domain LD1 based on a keyring generation request RQkg.

In operation S350, the storage controller may read out the first encrypted media encryption key eMEK1 from the non-volatile memory device, may generate the first media encryption key MEK1 by decrypting the first encrypted media encryption key eMEK1 using the first key encryption key KEK1, may generate the first re-encrypted media encryption key eMEK1v1 by re-encrypting the first media encryption key MEK1 using the first version key encryption key KEK1v1, and may store the first re-encrypted media encryption key eMEK1v1 in the non-volatile memory device.

In operation S360, the storage controller may read out the second encrypted media encryption key eMEK2 from the non-volatile memory device, may generate the second media encryption key MEK2 by decrypting the second encrypted media encryption key eMEK2 using the first key encryption key KEK1, may generate the second re-encrypted media encryption key eMEK2v1 by re-encrypting the second media encryption key MEK2 using the first version key encryption key KEK1v1, and may store the second re-encrypted media encryption key eMEK2v1 in the non-volatile memory device.

In operation S370, the storage controller may register the first key encryption key KEK1 and the first version key encryption key KEK1v1 in a keyring table of the first locking domain LD1. The first key encryption key KEK1 and the first version key encryption key KEK1v1 may be collectively referred to as a “keyring” or a “part of a keyring”.

In operation S380, the storage controller may perform a check operation based on a check request RQc. The check operation may include checking version information and/or activation status information of each of the first key encryption key KEK1 and/or the first version key encryption key KEK1v1.

In operation S390, the storage controller may perform a key rotation operation of the first locking domain LD1 based on a key rotation request RQkr. For example, the key rotation operation may include at least one of generating the second version key encryption key KEK1v2 dedicated to the first locking domain LD1 and registering the second version key encryption key KEK1v2 in the keyring table, deleting the first key encryption key KEK1 or the first version key encryption key KEK1v1, deactivating the first key encryption key KEK1 or the first version key encryption key KEK1v1, and activating the first key encryption key KEK1 or the first version key encryption key KEK1v1.

The above description refers to detailed example embodiments for carrying out the inventive concepts. The inventive concepts may include example embodiments in which a design is changed simply or which are easily changed, as well as the example embodiments described above. In addition, technologies that are easily changed and implemented by using the above example embodiments may be included in the inventive concepts. While the inventive concepts has been described with reference to example embodiments described above, it will be apparent to those of ordinary skill in the art that various changes and modifications may be made thereto without departing from the spirit and scope of the inventive concepts as set forth in the following claims.

According to at least one example embodiment of the inventive concepts, a storage controller that assigns a locking domain, a storage device including the same, and a method of operating the same are provided.

Moreover, according to one or more example embodiments of the inventive concepts, a key encryption key (KEK) dedicated to a locking domain is compatible between a plurality of namespaces of the locking domain, thereby reducing the resource burden and complexity of key management. Besides, a key rotation operation of key encryption key becomes easier, and thus the security and recoverability of user data may be increased.

What is claimed is:

1. A storage device comprising:
a non-volatile memory device; and
a storage controller configured to,
assign a first locking domain for first user data of a first namespace and second user data of a second namespace based on a first assignment request of a host device,
generate a first key encryption key (KEK) dedicated to the first locking domain,
store first encrypted user data in the non-volatile memory device, the first encrypted user data generated by encrypting the first user data using a first media encryption key (MEK),
store second encrypted user data in the non-volatile memory device, the second encrypted user data generated by encrypting the second user data using a second MEK,
store a first encrypted MEK in the non-volatile memory device, the first encrypted MEK generated by encrypting the first MEK using the first KEK,
store a second encrypted MEK in the non-volatile memory device, the second encrypted MEK generated by encrypting the second MEK using the first KEK, and
manage at least part of the first namespace and at least part of the second namespace based on a first encryption policy associated with the first locking domain.

2. The storage device of claim 1, wherein the first locking domain is a global range of a locking object generated based on a trusted computing group (TCG) Opal standard.

3. The storage device of claim 1, wherein the storage controller is further configured to:
assign all logical block addresses (LBAs) of the first namespace for the first user data; and
assign all of the LBAs of the first namespace to the first locking domain.

4. The storage device of claim 1, wherein the storage controller is further configured to:
assign a subset of LBAs among all of the LBAs of the first namespace for the first user data; and
assign the subset of LBAs of the first namespace to the first locking domain.

5. The storage device of claim 1, wherein the storage controller is further configured to:
store a first encrypted KEK in the non-volatile memory device, the first encrypted KEK generated by encrypting the first KEK.

6. The storage device of claim 5, wherein the storage controller is further configured to:
set a lock enabled value of the first locking domain to a first Boolean value or a second Boolean value;
block access to the first encrypted KEK while the lock enabled value is set to the first Boolean value; and
allow access to the first encrypted KEK while the lock enabled value is set to the second Boolean value.

7. The storage device of claim 1, wherein the storage controller is further configured to:
assign the first user data, the second user data, and third user data of a third namespace to the first locking domain based on the first assignment request of the host device;
store third encrypted user data in the non-volatile memory device, the third encrypted user data generated by encrypting the third user data using a third MEK;
store a third encrypted MEK in the non-volatile memory device, the third encrypted MEK generated by encrypting the third MEK using the first KEK; and
manage at least part of the third namespace based on the first encryption policy associated with the first locking domain.

8. The storage device of claim 1, wherein the storage controller is further configured to:
assign a third user data of a third namespace to a second locking domain based on a second assignment request of the host device;
generate a second KEK dedicated to the second locking domain;
store third encrypted user data in the non-volatile memory device, the third encrypted user data generated by encrypting the third user data using a third MEK;
store a third encrypted MEK in the non-volatile memory device, the third encrypted MEK generated by encrypting the third MEK using the second KEK; and
manage at least part of the third namespace based on a second encryption policy associated with the second locking domain.

9. The storage device of claim 8, wherein the storage controller is further configured to:
assign fourth user data of the third namespace to a third locking domain based on a third assignment request of the host device;
generate a third KEK dedicated to the third locking domain;
store fourth encrypted user data in the non-volatile memory device, the fourth encrypted user data generated by encrypting the fourth user data using a fourth MEK;
store a fourth encrypted MEK in the non-volatile memory device, the fourth encrypted MEK generated by encrypting the fourth MEK using the third KEK;
manage a first subset of LBAs of the third namespace based on the second encryption policy, the first subset of the LBAs of the third namespace corresponding to the third user data; and
manage a second subset of LBAs of the third namespace based on a third encryption policy associated with the third locking domain, the second subset of LBAs of the third namespace corresponding to the fourth user data.

10. The storage device of claim 9, wherein
the first locking domain is a global range of a locking object generated based on a TCG Opal standard;
the second locking domain is a first non-global range of the locking object generated based on the TCG Opal standard; and
the third locking domain is a second non-global range of the locking object generated based on the TCG Opal standard.

11. The storage device of claim 1, wherein the storage controller is further configured to:
generate a second KEK dedicated to the first locking domain based on a keyring generation request;
generate a first decrypted MEK, the generating the first decrypted MEK including reading the first encrypted MEK from the non-volatile memory device, and decrypting the first encrypted MEK using the first KEK;
store a first re-encrypted MEK in the non-volatile memory device, the first re-encrypted MEK generated by re-encrypting the first decrypted MEK using the second KEK;
generate a second decrypted MEK, the generating the second decrypted MEK including reading the second encrypted MEK from the non-volatile memory device, and decrypting the second encrypted MEK using the first KEK;
store a second re-encrypted MEK in the non-volatile memory device, the second re-encrypted MEK generated by re-encrypting the second decrypted MEK using the second KEK; and
register the first KEK and the second KEK in a keyring table associated with the first locking domain.

12. The storage device of claim 11, wherein the storage controller is further configured to:
perform a key rotation operation of the first locking domain based on a key rotation request; and
the key rotation operation includes at least one of:
generating a third KEK dedicated to the first locking domain, and then registering the third KEK in the keyring table,
deleting the first KEK or the second KEK,
deactivating the first KEK or the second KEK, and
activating the first KEK or the second KEK.

13. The storage device of claim 12, wherein the storage controller is further configured to:
receive the key rotation request from the host device; or
generate the key rotation request based on a security policy of the storage controller.

14. The storage device of claim 11, wherein the storage controller is further configured to:
store first version information and first activation status information of the first KEK in the keyring table; and
store second version information and second activation status information of the second KEK in the keyring table.

15. The storage device of claim 14, wherein the storage controller is further configured to:
receive a check request of the first KEK from the host device; and
provide the first version information and the first activation status information of the first KEK to the host device based on the check request.

16. A storage controller comprising:
a locking domain table;
an assignment manager configured to,
assign a first locking domain for first user data of a first namespace and second user data of a second namespace based on a first assignment request of a host device, and
store first range information of the first locking domain in the locking domain table; and
an encryption manager configured to,
generate a first key encryption key (KEK) dedicated to the first locking domain based on the first range information;
generate a first media encryption key (MEK) for encrypting the first user data;
store a first encrypted MEK in a non-volatile memory device, the first encrypted MEK generated by encrypting the first MEK using the first KEK;
generate a second MEK for encrypting the second user data;
store a second encrypted MEK in the non-volatile memory device, the second encrypted MEK generated by encrypting the second MEK using the first KEK; and
manage at least part of the first namespace and at least part of the second namespace based on a first encryption policy associated with the first locking domain.

17. The storage controller of claim 16, wherein
the assignment manager is further configured to,
assign a second locking domain for third user data of a third namespace based on a second assignment request of the host device, and
store second range information of the second locking domain in the locking domain table; and
the encryption manager is further configured to,
generate a second KEK dedicated to the second locking domain based on the second range information;
generate a third MEK for encrypting the third user data,
store a third encrypted MEK in the non-volatile memory device, the third encrypted MEK generated by encrypting the third MEK using the second KEK, and
manage at least part of the third namespace based on a second encryption policy associated with the second locking domain.

18. A method of operating a storage controller communicating with a host device and a non-volatile memory device, the method comprising:
receiving a first assignment request from the host device;
assigning a first locking domain for first user data of a first namespace and second user data of a second namespace based on the first assignment request, at least part of the first namespace and at least part of the second namespace being managed based on a first encryption policy associated with the first locking domain;
generating a first KEK dedicated to the first locking domain;
generating a first MEK for encrypting the first user data;
storing a first encrypted MEK in the non-volatile memory device, the first encrypted MEK generated by encrypting the first MEK using the first KEK;
generating a second MEK for encrypting the second user data; and
storing a second encrypted MEK in the non-volatile memory device, the second encrypted MEK generated by encrypting the second MEK using the first KEK.

19. The method of claim 18, further comprising:
receiving a second assignment request from the host device;
assigning a second locking domain for third user data of a third namespace based on the second assignment request, at least part of the third namespace being managed based on a second encryption policy associated with the second locking domain;
generating a second KEK dedicated to the second locking domain;
generating a third MEK for encrypting the third user data; and
storing a third encrypted MEK in the non-volatile memory device, the third encrypted MEK generated by encrypting the third MEK using the second KEK.

20. The method of claim 18, further comprising:
generating a second KEK dedicated to the first locking domain based on a keyring generation request;
generating a first decrypted MEK, the generating the first decrypted MEK including reading the first encrypted MEK from the non-volatile memory device, and decrypting the first encrypted MEK using the first KEK;
storing a first re-encrypted MEK in the non-volatile memory device, the first re-encrypted MEK generated by re-encrypting the first decrypted MEK using the second KEK;
generating a second decrypted MEK, the generating the second decrypted MEK including reading the second encrypted MEK from the non-volatile memory device, and decrypting the second encrypted MEK using the first KEK;
storing a second re-encrypted MEK in the non-volatile memory device, the second re-encrypted MEK generated by re-encrypting the second decrypted MEK using the second KEK;
registering the first KEK and the second KEK in a keyring table associated with the first locking domain; and
performing a key rotation operation of the first locking domain based on a key rotation request,
the key rotation operation including at least one of:
generating a third KEK dedicated to the first locking domain and then registering the third KEK in the keyring table,
deleting the first KEK or the second KEK,
deactivating the first KEK or the second KEK, and
activating the first KEK or the second KEK.
